(19) United States
(12) Patent Application Publication
(10) Pub. No.: US 2025/0287485 A1
(43) Pub. Date: Sep. 11, 2025

(54) LOW-HEADROOM CONSTANT CURRENT LIGHT-EMITTING DIODE (LED) DRIVER CIRCUIT WITH REDUCED POWER SUPPLY RIPPLE

(71) Applicant: CIRRUS LOGIC INTERNATIONAL SEMICONDUCTOR LTD., Edinburgh (GB)

(72) Inventors: Vamsikrishna Parupalli, Austin, TX (US); Zhong You, Austin, TX (US)

(21) Appl. No.: 19/039,753

(22) Filed: Jan. 28, 2025

Related U.S. Application Data
(60) Provisional application No. 63/562,686, filed on Mar. 7, 2024.

(51) Int. Cl. H05B 45/36; H05B 45/14; H05B 45/347

(52) U.S. Cl. CPC H05B 45/36; H05B 45/14; H05B 45/347

(57) ABSTRACT

A driver circuit provides a load current to a light-emitting diode (LED) or other load, includes a driver stage having an output coupled to the light-emitting diode and having a power supply input for receiving input current having a DC component and a converter output voltage ripple waveform component. A multi-path controller sets a target value of the DC component of the load current according to a control value from a feedforward path and controls the DC component of the load current with a low-frequency feedback path and compensates for the converter output voltage ripple waveform component with a high-frequency feedback path to cancel at least a portion of a component of the converter output voltage ripple waveform conducted from the driver stage to the load. A current sensing circuit may provide a measure of the load current and the controller may implement a supply ripple compensator.

### BACKGROUND

### 1. Field of Disclosure

The field of representative embodiments of this disclosure relates to constant-current driver circuits, and in particular to a constant-current light-emitting diode (LED) driver with reduced power supply ripple.

### 2. Background

LEDs have become the standard lighting source in many applications, and particular, have found their way into high-intensity lighting applications, including their use in flash lighting for digital cameras and mobile device camera flash. LEDs are typically driven by a constant-current driver circuit, and frequently the LEDs are connected in a series stack in order to provide a greater lighting intensity. Driving an LED stack in such a device often requires a power supply voltage greater than that available from the device's internal battery, and therefore a boost converter is used to generate a power supply voltage from which the constant-current driver may be operated.

FIG. 1 shows a simplified schematic of such a prior art LED driver circuit 10. A reference current mirror formed by a transistor N1 and a transistor N2 receives the output of a current-output digital-to-analog-converter (IDAC) 12 that receives an output current control value ICTL at an input. A pair of P-channel transistors P1, P2 receive the output of an amplifier A1 that compares an output voltage Vₒᵤₜ of LED driver circuit 10, which is the output voltage across a stack 18 of LEDs D1-D3 that are supplied with an output current I_{LED} conducted through transistor P2 from a power supply input, which is supplied with a power supply voltage V_{boost} from a boost converter 14 that receives an input voltage V_{batt} from a battery B1 and raises power supply voltage V_{boost} to a voltage level sufficient to maintain the required forward voltage across LED stack 18 plus the voltage drop across transistor P2. Transistor P1 is scaled to transistor P2 by a large ratio, e.g., 100:1 of 1000:1, so that the reference current mirror formed by transistors N1, N2 conducts a current that is a small fraction of output current I_{LED} and which controls the DC value of output current I_{LED}, according to the reference current provided from IDAC 12. While the LED driver circuit 10 illustrated in FIG. 1 has low complexity and good control of the average (DC) value of output current I_{LED}, LED driver circuit 10 may suffer from reduced efficiency. The efficiency of LED driver circuit 10 depends on the efficiency of boost converter 14 combined with the required headroom, i.e., the voltage margin between input voltage V_{batt} and output voltage Vₒᵤₜ, which must be low enough to ensure that LED stack 18 may be driven to a voltage that satisfies the desired current level requirement for the system, while not wasting substantial energy in the driver circuit.

The reduced headroom required for efficiency of LED driver circuit 10 leads to a lack of loop bandwidth available to overcome ripple on the output of boost converter 14, as output voltage Vₒᵤₜ may saturate due to the ripple. Further, the non-linear relationship between output current and output voltage Vₒᵤₜ, due to the non-linearity of the voltage drop across the LED stack, may lead to dramatic changes in LED operating current for small changes in driver output voltage, which make it difficult to maintain a constant LED current when power supply ripple is present on the output of the driver. In order to provide efficient operation, the voltage drop across P2 must be maintained at a low value, and a component due to the output ripple voltage of boost converter 14 typically appears on output voltage Vₒᵤₜ. Therefore, a component due to boost converter output ripple voltage also appears in output current I_{LED}, since the architecture of LED driver circuit 10 does not have sufficient loop bandwidth to cancel the ripple component at the frequency of the voltage ripple, i.e., at the switching frequency of boost converter 12. A diagram 20 shown in FIG. 2 illustrates signal waveforms within prior art LED driver circuit 10 of FIG. 1. As the DC value of power supply voltage V_{boost} is varied, some variation occurs in output voltage Vₒᵤₜ and output current I_{LED}, due to the increased or decreased headroom, but in general, the ripple present in both output voltage Vₒᵤₜ and output current I_{LED} remains present, as LED driver circuit 10 of FIG. 1 does not have the bandwidth to cancel the ripple, which is exhibited in the figure as the triangular waveforms of output voltage Vₒᵤₜ and output current I_{LED}.

Therefore, it would be advantageous to provide a constant-current LED driver circuit and method of operation that provide improved efficiency and rejection of boost converter ripple.

### SUMMARY

Improved efficiency and boost converter ripple reduction is achieved in driver circuits, which may be LED driver circuits, and their methods of operation.

In one aspect, the circuit may be a circuit that provides a load current to a light-emitting diode (LED), including a driver stage having an output coupled to the light-emitting diode. The driver stage has a power supply input for receiving input current having a DC component and a converter output voltage ripple waveform component. The circuit also includes a multi-path controller that provides the input of the driver stage and sets a target value of the DC component of the load current according to a control value from a feedforward path. The multi-path controller controls the DC component of the load current with a low-frequency feedback path and compensates for the converter output voltage ripple waveform component with a high-frequency feedback path to cancel at least a portion of a component of the converter output voltage ripple waveform conducted from the driver stage to the load.

In another aspect, the circuit may be a circuit that provides a load current to a load, including a driver stage having an output coupled to the load. The driver stage has a power supply input for receiving input current having a DC component and a converter output voltage ripple waveform component. The circuit also includes a current sensing circuit coupled to the driver stage and having an output providing a measure of the load current. The circuit further includes a feedforward control path having an output coupled to an input of the driver stage, and an input receiving a control value that sets a target value of the DC component of the load current, a low-frequency feedback control path having an output coupled to the input of the driver stage and an input coupled to the output of the current sensing circuit to control the DC component of the load current, and a supply ripple compensator having an output coupled to the input of the driver stage and that has an input for receiving a representation of the converter output voltage ripple waveform component to cancel at least a portion of a component of the converter output voltage ripple waveform conducted from the driver stage to the load.

The summary above is provided for brief explanation and does not restrict the scope of the claims. The description below sets forth example embodiments according to this disclosure. Further embodiments and implementations will be apparent to those having ordinary skill in the art. Persons having ordinary skill in the art will recognize that various equivalent techniques may be applied in lieu of, or in conjunction with, the embodiments discussed below, and all such equivalents are encompassed by the present disclosure.

### BRIEF DESCRIPTION OF THE DRAWINGS

FIG. 1 is a simplified schematic diagram illustrating a prior art LED driver circuit 10.

FIG. 2 is a signal waveform diagram 20 illustrating signals within prior art LED driver circuit 10 of FIG. 1.

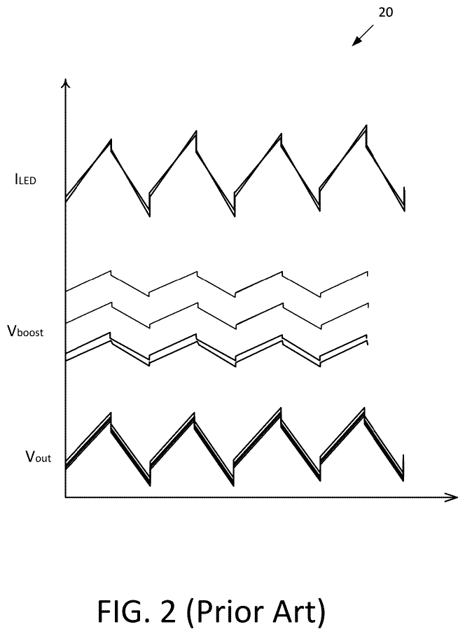

FIG. 3 is a block diagram illustrating an example LED driver circuit 30, in accordance with an embodiment of the disclosure.

FIG. 4 is a signal waveform diagram 40 illustrating signals within example LED driver circuit 30 of FIG. 3, in accordance with an embodiment of the disclosure.

FIG. 5 is a schematic diagram illustrating an example LED driver circuit 50 that may be used to implement example LED driver circuit 30 of FIG. 3, in accordance with an embodiment of the disclosure.

### DETAILED DESCRIPTION OF ILLUSTRATIVE EMBODIMENT

The present disclosure encompasses circuits and integrated circuits that implement LED constant-current drivers, or drivers for other devices requiring low-headroom operation when operated from a switching power supply having substantial output voltage ripple. A driver circuit provides a load current to an LED or other load, and includes a driver stage for supplying the load current. A power supply input of the driver stage receives a voltage having a DC component and a converter output voltage ripple waveform component. A multi-path controller that provides an input to the driver stage sets a target value of the DC component of the load current according to a control value from a feedforward path, controls the DC component of the load current with a low-frequency feedback path, and compensates for the converter output voltage ripple waveform component with a high-frequency feedback path to cancel at least a portion of a component of the converter output voltage ripple waveform conducted from the driver stage to the load. A current sensing circuit may provide a measure of the load current, and the controller may implement a supply ripple compensator.

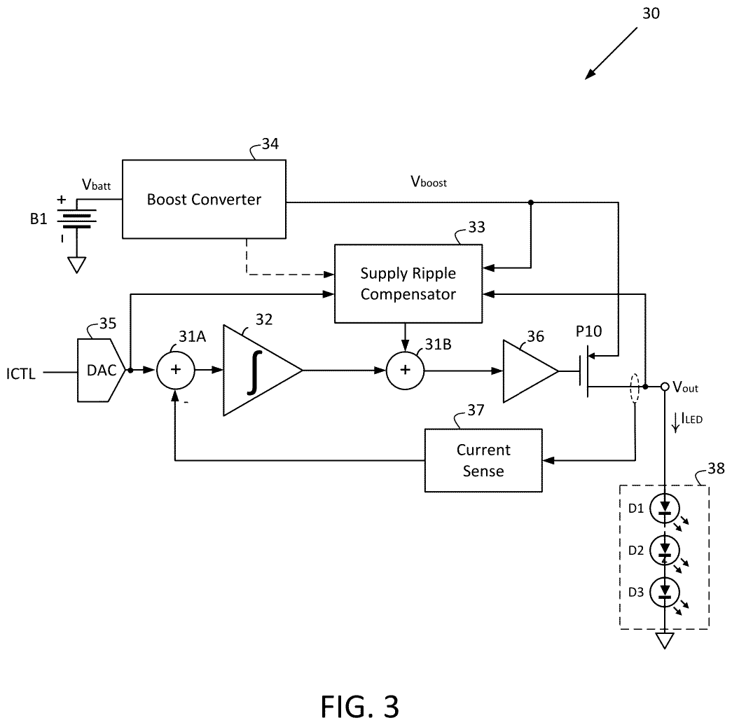

Referring now to FIG. 3, a block diagram illustrating an example LED driver circuit 30 is shown, in accordance with an embodiment of the disclosure. A transistor P10 supplies output voltage Vₒᵤₜ, which causes output current I_{LED} to flow through a stack 38 of LEDs D1-D3. The source terminal of transistor P10 is supplied with power supply voltage V_{boost} from a boost converter 34 that receives input voltage V_{batt} from battery B1 and raises power supply voltage V_{boost} to a voltage level sufficient to maintain the required forward voltage across LED stack 38 plus the voltage drop across transistor P10. A digital-to-analog-converter (DAC) 35 receives an output current control value ICTL at an input and generates an input to a combiner 31A as part of a feed-forward path that proceeds through an integrator 32, a second combiner 31B, and a high-bandwidth pre-driver amplifier 36 that drives a gate of a driver stage formed by P-channel transistor P10. Integrator 32 provides a high-gain low-frequency control with respect to the current control input provided from DAC 35. The average (DC) current level of output current I_{LED} is controlled by a low-frequency feedback path provided by a current sensing block 37 that measures a current at the drain terminal of transistor P10 and provides a feedback signal that is subtracted from the commanded current level set by DAC 35 prior to integration by integrator 32. A supply ripple compensator 33 receives a representation of the ripple component of the output voltage of boost converter 34, which may be power supply voltage V_{boost} or a feed-forward signal coupled directly from boost converter 34. Supply ripple compensator 33 also receives the LED current control value from the output of DAC 35, as well as output voltage Vₒᵤₜ, so that supply ripple compensator 33 may provide a compensation input to combiner 31B that acts as a high-frequency feedback signal, i.e., a signal that has a bandwidth that includes at least the switching frequency of boost converter 34, to cancel at least a portion of the ripple component of power supply voltage V_{boost} that would otherwise appear on output voltage Vₒᵤₜ, and thereby modulating output current I_{LED} with the output ripple waveform generated by boost converter 34.

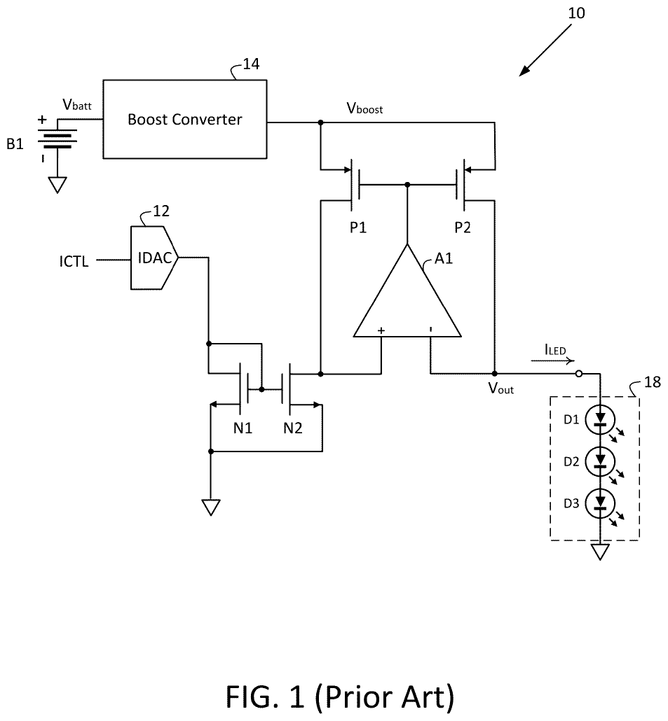

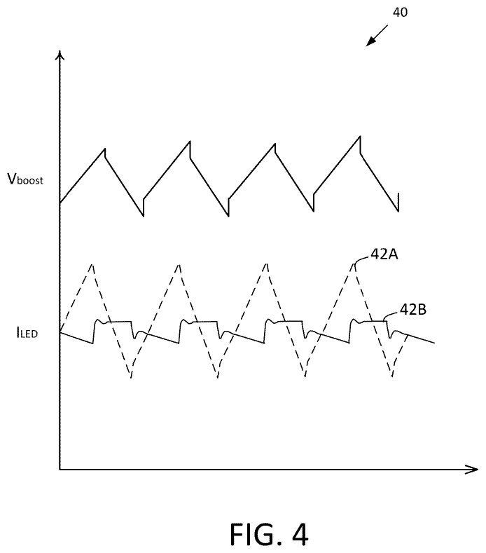

Referring now to FIG. 4, a signal waveform diagram 40 illustrating signals within example LED driver circuit 30 of FIG. 3 is shown, in accordance with an embodiment of the disclosure. Power supply voltage V_{boost} is shown for a fixed value of ripple and headroom, and a first waveform 42A illustrates a value of output current I_{LED} and the consequent current ripple that would be produced by prior art LED driver circuit 10 illustrated in FIG. 1, compared to a value of output current I_{LED} and the consequent current ripple produced by example LED driver circuit 30 of FIG. 3, which is illustrated by second waveform 42B. As can be seen, the peak amplitude of the ripple in output current I_{LED} has been reduced by almost an order of magnitude and the overall energy associated with the ripple is reduced by an order of magnitude or more.

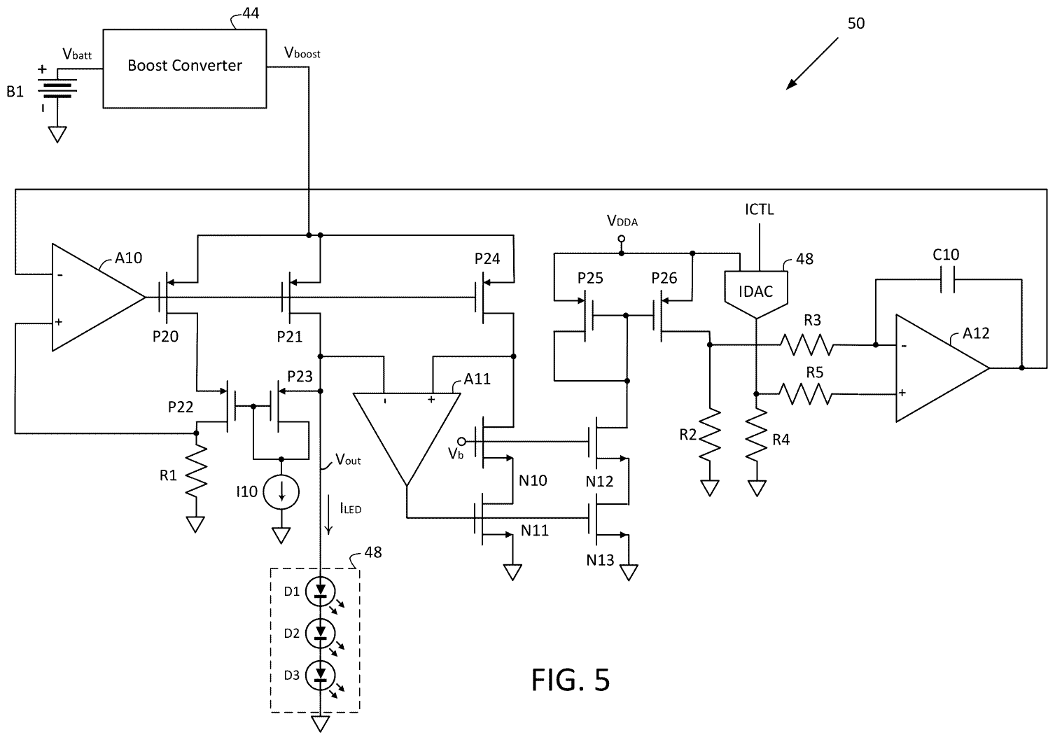

Referring now to FIG. 5 a schematic diagram illustrating an example LED driver circuit 50 that may be used to implement example LED driver circuit 30 of FIG. 3 is shown, in accordance with an embodiment of the disclosure. A transistor P21 supplies output voltage Vₒᵤₜ, which causes output current I_{LED} to flow through a stack 48 of LEDs D1-D3. The source terminal of transistor P21, as well as the source terminals of other mirrored transistors P20 and P24, is supplied with power supply voltage V_{boost} from a boost converter 44 that receives input voltage V_{batt} from battery B1 and raises power supply voltage V_{boost} to a voltage level sufficient to maintain the required forward voltage across LED stack 48 plus the voltage drop across transistor P21. A current-output digital-to-analog-converter (IDAC) 48 receives an output current control value ICTL at an input and generates an input to an integrator stage formed by amplifier A12, capacitor C10, and resistors R2-R5. The integrator stage also performs the function of combiner 31A in example LED driver circuit 30 of FIG. 3, by receiving the current output of IDAC 48 at a non-inverting input terminal of amplifier A12 via the voltage divider formed by resistors R4, R5 and a feedback signal representing output current I_{LED}. The above-described feedback signal is provided from a current mirror formed by transistors P25, P26, which mirrors a current conducted through transistors N12 and N13, and which matches the current conducted through transistor P24, transistor N10 and transistor N11. An amplifier A11 generates the input to the mirror leg provided by transistor P25 through transistors N10-N13 and provides the low-frequency feedback signal corresponding to output current I_{LED}, which is compared by the differential inputs of amplifier A12 to the commanded current level provided by IDAC 48. Transistors N10 and N12 are biased by a bias voltage V_{b} to perform voltage level shifting, since the output driver implemented by transistor P21 and supply ripple compensator/combiner implemented by amplifier 10 and associated components are all operated from power supply voltage V_{boost}, while IDAC 48 and the current mirror formed by transistors P25 and P26 are operated from a power supply V_{DDA} which is generally of lower voltage than power supply voltage V_{boost} and does not contain the boost converter ripple. The high-bandwidth pre-driver in example LED driver circuit 50 is provided by an amplifier A10, which receives a voltage across a resistor R1 at a non-inverting input and which is proportional to a current conducted through transistors P22 and P20, which has a DC level set by a current source 110 that is a copy of the output current of IDAC 48, through a transistor P23, but that will also contain a component due to the ripple voltage on power supply voltage V_{boost}. At an inverting input, amplifier A10 receives the output of amplifier A12, performing the function of combiner 31B and supply ripple compensator 33 in example LED driver circuit 30 of FIG. 3.

In summary, this disclosure shows and describes circuits and their methods of operation. In some example embodiments, the circuit may be a circuit that provides a load current to a light-emitting diode (LED) and that includes a driver stage having an output coupled to the light-emitting diode. The driver stage may have a power supply input for receiving input current having a DC component and a converter output voltage ripple waveform component, and a multi-path controller having an output coupled to an input of the driver stage that sets a target value of the DC component of the load current according to a control value from a feedforward path. The multi-path controller may control the DC component of the load current with a low-frequency feedback path and may compensate for the converter output voltage ripple waveform component with a high-frequency feedback path to cancel at least a portion of a component of the converter output voltage ripple waveform conducted from the driver stage to the load.

In some example embodiments, the circuit may provide a load current to a load, and may include a driver stage having an output coupled to the load. The driver stage may have a power supply input for receiving input current having a DC component and a converter output voltage ripple waveform component. The circuit may include a current sensing circuit coupled to the driver stage and having an output providing a measure of the load current, a feedforward control path having an output coupled to an input of the driver stage, and an input receiving a control value that sets a target value of the DC component of the load current. The circuit may also include a low-frequency feedback control path having an output coupled to the input of the driver stage, an input coupled to the output of the current sensing circuit to control the DC component of the load current, and a supply ripple compensator having an output coupled to the input of the driver stage and that has an input for receiving a representation of the converter output voltage ripple waveform component to cancel at least a portion of a component of the converter output voltage ripple waveform conducted from the driver stage to the load.

In some example embodiments, the load may be an LED and the circuit may be an LED operating current supply circuit. In some example embodiments, the low-frequency feedback control path may have an output coupled to an element of the feedforward control path that compares the DC component of the load current to a DC control value supplied to the element of the feedforward control path to generate low-frequency feedback provided to the input of the driver stage. In some example embodiments, the circuit may further include an input terminal that receives the representation of the converter output voltage ripple waveform component from an external switching converter circuit. In some example embodiments, the supply ripple compensator may have an input coupled to the feedforward control path and that receives the control value therefrom.

In some example embodiments, the supply ripple compensation circuit may have a first input coupled to the output of the driver stage and a second input coupled to the power supply input of the driver stage, and the representation of the converter output voltage ripple waveform may be obtained from one or both of a voltage at the output of the driver stage and a voltage at the power supply input of the driver stage. In some example embodiments, the supply ripple compensator may have an output coupled to a combiner within the feedforward control path that combines the output of the supply ripple compensator with a state of the feedforward control path to generate a signal at the input of the driver stage that contains a DC control value component and a cancelation component that causes cancellation of the at least a portion of the component of the converter output voltage ripple waveform conducted from the driver stage to the load. In some example embodiments, the feedforward control path may include an integrator, and the combiner may have an input coupled to an output of the integrator. In some example embodiments, the circuit may include a digital-to-analog converter (DAC) for generating the control value provided to the feedforward path from a digital control value.

In some example embodiments, the driver stage may include a current mirror having a first transistor having a source connected to the power supply input and a drain connected to the output of the driver stage and a second transistor having a gate connected to a gate of the first transistor, a source connected to the power supply input, and a drain that receives a current corresponding to the control value of the feedforward path and that is coupled to the gate of the first transistor and the gate of the second transistor to form the current mirror. In some example embodiments, non-linearity of an impedance of the load or saturation of the first transistor due to low voltage headroom may cause an open-loop variation in load current due to the boost converter output waveform component, which may be at least partially canceled by operation of the supply ripple compensator. In some example embodiments, the current sensing circuit may include a third transistor having a gate connected to a gate of the first transistor and a source connected to the power supply input, whereby a current conducted through a channel of the third transistor is mirrored with currents of the current mirror, and a voltage controlled current source having an input coupled to the output of the driver and the drain of the third transistor that generates the output of the current sensing circuit.

While the disclosure has shown and described particular embodiments of the techniques disclosed herein, it will be understood by those skilled in the art that the foregoing and other changes in form, and details may be made therein without departing from the spirit and scope of the disclosure. For example, the techniques shown above may be applied to a circuit and method for driving a load other than LEDs.

What is claimed is:

1. A circuit that provides a load current to a load, the circuit comprising:
a driver stage having an output coupled to the load, the driver having a power supply input for receiving input current having a DC component and a converter output voltage ripple waveform component;
a current sensing circuit coupled to the driver stage and having an output providing a measure of the load current;
a feedforward control path having an output coupled to an input of the driver stage and an input receiving a control value that sets a target value of the DC component of the load current;
a low-frequency feedback control path having an output coupled to the input of the driver stage and an input coupled to the output of the current sensing circuit to control the DC component of the load current; and
a supply ripple compensator having an output coupled to the input of the driver stage and that has an input for receiving a representation of the converter output voltage ripple waveform component to cancel at least a portion of a component of the converter output voltage ripple waveform conducted from the driver stage to the load.

2. The circuit of claim 1, wherein the load is an LED and the circuit is an LED operating current supply circuit.

3. The circuit of claim 1, wherein the low-frequency feedback control path has an output coupled to an element of the feedforward control path that compares the DC component of the load current to a DC control value supplied to the element of the feedforward control path to generate low-frequency feedback provided to the input of the driver stage.

4. The circuit of claim 1, further comprising an input terminal that receives the representation of the converter output voltage ripple waveform component from an external switching converter circuit.

5. The circuit of claim 1, wherein the supply ripple compensator has an input coupled to the feedforward control path and receives the control value.

6. The circuit of claim 1, wherein the supply ripple compensation circuit has a first input coupled to the output of the driver stage and a second input coupled to the power supply input of the driver stage, wherein the representation of the converter output voltage ripple waveform is obtained from one or both of a voltage at the output of the driver stage and a voltage at the power supply input of the driver stage.

7. The circuit of claim 6, wherein the supply ripple compensator has an output coupled to a combiner within the feedforward control path that combines the output of the supply ripple compensator with a state of the feedforward control path to generate a signal at the input of the driver stage that contains a DC control value component and a cancelation component that causes cancellation of the at least a portion of the component of the converter output voltage ripple waveform conducted from the driver stage to the load.

8. The circuit of claim 6, wherein the feedforward control path includes an integrator, and wherein the combiner has an input coupled to an output of the integrator.

9. The circuit of claim 6, further comprising a digital-to-analog converter (DAC) for generating the control value provided to the feedforward path from a digital control value.

10. The circuit of claim 1, wherein the driver stage comprises a current mirror comprising:
a first transistor having a source connected to the power supply input and a drain connected to the output of the driver stage; and
a second transistor having a gate connected to a gate of the first transistor, a source connected to the power supply input, and a drain that receives a current corresponding to the control value of the feedforward path and that is coupled to the gate of the first transistor and the gate of the second transistor to form the current mirror.

11. The circuit of claim 10, wherein non-linearity of an impedance of the load or saturation of the first transistor due to low voltage headroom causes an open-loop variation in load current due to the boost converter output waveform component, which is at least partially canceled by operation of the supply ripple compensator.

12. The circuit of claim 10, wherein the current sensing circuit comprises:
a third transistor having a gate connected to a gate of the first transistor and a source connected to the power supply input, whereby a current conducted through a channel of the third transistor is mirrored with currents of the current mirror; and
a voltage controlled current source having an input coupled to the output of the driver and the drain of the third transistor that generates the output of the current sensing circuit.

13. A circuit that provides a load current to a light-emitting diode (LED), the circuit comprising:
a driver stage having an output coupled to the light-emitting diode, the driver having a power supply input for receiving input current having a DC component and a converter output voltage ripple waveform component; and
a multi-path controller having an output coupled to an input of the driver stage that sets a target value of the DC component of the load current according to a control value from a feedforward path, wherein the multi-path controller controls the DC component of the load current with a low-frequency feedback path and compensates for the converter output voltage ripple waveform component with a high-frequency feedback path to cancel at least a portion of a component of the converter output voltage ripple waveform conducted from the driver stage to the load.

14. A method of providing a load current to a load, the method comprising:
supplying the load current to the load from a driver stage having an output coupled to the load, the driver having a power supply input for receiving input current having a DC component and a converter output voltage ripple waveform component;
sensing a measure of the load current with a current sensing circuit coupled to the driver stage;
setting a target value of the DC component of the load current according to a control value from a feedforward control path having an output coupled to an input of the driver stage and an input receiving the control value;
providing feedback from the current sensing circuit via a low-frequency feedback control path to control the DC component of the load current, the low-frequency feedback control path having an output coupled to the input of the driver stage and an input coupled to the output of the current sensing circuit; and
cancelling at least a portion of a component of the converter output voltage ripple waveform conducted from the driver stage to the load with a supply ripple compensator having an output coupled to the input of the driver stage and an input for receiving a representation of the converter output voltage ripple waveform component.

15. The method of claim 14, wherein the load is an LED and the method is a method of supplying an LED operating current.

16. The method of claim 14, further comprising comparing the DC component of the load current to a DC control value with an element of the feedforward control path that receives an output of low-frequency feedback control path to generate low-frequency feedback provided to the input of the driver stage.

17. The method of claim 14, further comprising receiving the representation of the converter output voltage ripple waveform component from an external switching converter circuit.

18. The method of claim 14, further comprising the supply ripple compensator receiving the control value from the feedforward control path.

19. The method of claim 14, wherein the supply ripple compensation circuit has a first input coupled to the output of the driver stage and a second input coupled to the power supply input of the driver stage, and wherein the method further comprises obtaining the representation of the converter output voltage ripple waveform from one or both of a voltage at the output of the driver stage and a voltage at the power supply input of the driver stage.

20. The method of claim 19, further comprising combining the output of the supply ripple compensator with a state of the feedforward control path to generate a signal at the input of the driver stage that contains a DC control value component and a cancelation component that causes cancellation of the at least a portion of the component of the converter output voltage ripple waveform conducted from the driver stage to the load.

21. The method of claim 19, wherein the feedforward control path includes an integrator, and wherein the combining combines an output of the integrator with the cancelation component.

22. The method of claim 19, further comprising generating the control value provided to the feedforward path from a digital control value with a digital-to-analog converter (DAC).

23. The method of claim 14, wherein the driver stage comprises a current mirror comprising:
a first transistor having a source connected to the power supply input and a drain connected to the output of the driver stage; and
a second transistor having a gate connected to a gate of the first transistor, a source connected to the power supply input, and a drain that receives a current corresponding to the control value of the feedforward path and that is coupled to the gate of the first transistor and the gate of the second transistor to form the current mirror.

24. The method of claim 23, wherein non-linearity of an impedance of the load or saturation of the first transistor due to low voltage headroom causes an open-loop variation in load current due to the boost converter output waveform component, which is at least partially canceled by the canceling.

25. The method of claim 23, wherein the current sensing circuit comprises:
a third transistor having a gate connected to a gate of the first transistor and a source connected to the power supply input, whereby a current conducted through a channel of the third transistor is mirrored with currents of the current mirror; and
a voltage controlled current source having an input coupled to the output of the driver and the drain of the third transistor that generates the output of the current sensing circuit.

26. A method of providing a load current to a light-emitting diode (LED), the method comprising:
providing current to the light-emitting diode from a power supply output having a DC component and a converter output voltage ripple waveform component;
setting a target value of the DC component of the load current according to a control value from a feedforward path; and
controlling the DC component of the load current with a low-frequency feedback path; and compensating for the converter output voltage ripple waveform component with a high-frequency feedback path to cancel at least a portion of a component of the converter output voltage ripple waveform conducted from the driver stage to the load.
